(19) United States
(12) Patent Application Publication
(10) Pub. No.: US 2005/0132229 A1
(43) Pub. Date: Jun. 16, 2005

(54) Virtual private network based on root-trust module computing platforms

(75) Inventors: Peng Zhang, Espoo (FI); Zheng Yan, Espoo (FI)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/987,762

(22) Filed: Nov. 12, 2004

Related U.S. Application Data
(60) Provisional application No. 60/519,343, filed on Nov. 12, 2003.

(51) Int. Cl. H04L 9/00

(52) U.S. Cl. 713/201

(57) ABSTRACT

A Virtual Private Network (VPN) system that includes a plurality of terminals, services and servers, part or all of which are root-trust module based platforms. The system provides the management of root-trust based platforms in the network, and enables verification among the platforms.

### CROSS-REFERENCED TO RELATED APPLICATIONS

This application claims the benefit of U.S. Provisional Application No. 60/519,343, filed Nov. 12, 2003, which is hereby incorporated herein in its entirety by reference.

### FIELD OF THE INVENTION

The present invention relates to computer networks and, more specifically, to a virtual private network (VPN) based on root-trust module computing platforms.

### BACKGROUND OF THE INVENTION

Trust is a crucial aspect in commerce and communications. Since electronic commerce runs on computing systems, e.g. personal computers (PCs), mobile phones and the like, enhancing trust in computing platforms is a fundamental issue and one that continues to grow in importance in the computing industry. With the rapid growth of mobile Internet, it naturally causes special concerns in the Internet and mobile communications.

TCG (Trust Computing Group) is an organization that will develop and promote open industry standard specifications forr trust computing hardware building blocks and software interfaces across multiple platforms, including Person Computer (PC) servers, Personal Digital Assistants (PDAs), digital telephones and the like. The organization, which was formed in 2003, aims to develop a new computing platform, i.e., the Trust Computing Platform (TCP), for the future that will provide for improved trust in computing.

TCP provides a computing platform on which users can not tamper with the application software, and where these applications can communicate securely with their authors and with each other. In addition, TCP will also make it much harder for a user to run unlicensed software. As such, the new platform provides an increased level of trust to its users, such that e-commerce and other services, e.g., Virtual private networking (VPN) can be safeguarded to the degree necessary. Thus, such a platform could become the basic building block for electronic commerce and VPN services.

The TCG has promulgated its main specification, 1.1a, and its personal computing specification. The specified trusted subsystem in the main specification behaves as a root-trust in the TCG trust concept. Root-trust is a key concept in building TCP. Root-trust refers to a methodology and the hardware and/or software components that implement root-trust thereby applying trust verification and establishment of trust at the inception of the implementation of a computing platform. Many vendors, such as Microsoft Corporation, Intel Corporation, and International Business Machines (IBM) Corporation, are becoming involved in trusted-computing technology, such as TCPA/TCG, Microsoft's Next Generation Secure Computing Base (NGSCB) and Intel's LaGrande.

The TCG envisions enhanced hardware and an improved operating system based on the TCP concepts. The enhanced hardware and operating system will interject trust into client, server, networking and communication platforms. TCG has the vision of ensuring privacy and enhancing security by enforcing the security through the trust. The computing and networking industries benefit from the TCG because the group has been successful in developing TCP specifications. These specifications can be used as guideline for implementation (currently limited to personal computers) and help simplify and accelerate the deployment, use, and manageability of security capability on computers.

Meanwhile, trust plays a key role in the context of virtual private networking (VPN), that is, VPN users must establish enough trust before they can communicate with each other. To set up the trust, the users must be verified by the VPN with user's credentials (e.g., certificates). Obviously, hackers pose a threat to the VPN, in that, they may tamper with user terminals to obtain user private data and gain access to the VPN. Therefore, the security of a VPN network largely relies on the security of local storage of user private data, hereafter referred to as, the security of the underlying computing platforms.

However, a VPN network may consist of a large set of terminals and network devices which can implement various computing platforms, e.g., workstation, PC, mobile telephone and the like. Currently, many VPN vendors (e.g., Nokia, Cisco Systems) offer their own computing platforms, for example, Nokia offers IPSO (Internet Protocol Security Operating system). As a result, with the widespread deployment of VPN and rapid demand for security in the Internet, it becomes more difficult for operators and customers to manage and maintain the security of all computing platforms (e.g., terminals and network devices) under control in their networks. For example, a mobile operator may want to create a mobile-commerce service for its users, which requires high-level security. As such, the users' mobile telephones should be secure devices with up-to-date configuration. In this instance, the mobile operator meets a challenge to manage the security of the service, e.g., how to prevent the users from using the service with insecure devices, how to apply up-to-date software/configurations to different devices from different vendors and how to enable verification between different devices and different software.

Providing advanced trust into VPN networks has proven to be problematic. First, VPN networks lack a means to enable trust among computing platforms from different manufactures. For example, applications with Company A application can be trusted by Company A devices but may not be recognized by Company B devices. Moreover, from a VPN management point of view, it is difficult to mange the security of a large number of computing platforms. This problem is exasperated in the mobile security market. Since different mobile device vendors provide different security solutions for their products, it is difficult, and in some instances impossible, for mobile service operators to manage the security of diverse mobile products in order to successfully run security-related services. In theory, this problem could be solved by establishing a world-wide (or at least operator-wide root-trust, which would be trusted by all the mobile products. However, the problem with this type of global or user-wide solution is that the manufacturers or service providers do not desire to empower one entity with this amount of control or power.

Second, none of the existing VPN systems can ensure that the data or components on the remote user terminal are controlled according to the VPN owner's security requirements, especially during the during the VPN connection and after disconnection. The VPN server is unaware as to whether the user terminal platform can be trusted or not, even though the user verification is successful. Especially, after the connection is established, the user could be compromised and installing or changing platform hardware or software could open the door to being attacked. Particularly, data accessed and downloaded from the VPN can be further copied and forwarded to other terminals after the VPN connection has been terminated. The user can conduct this illegal operation using various ways, e.g. disk copy of confidential files, send emails to other persons, etc. VPN operators depend on user loyalty to address this potential security problem.

Many current VPN products lack means to support trustworthiness. Such products cannot check the identities and/or configuration of remote computing platforms in order to ensure that the remote platforms are also well secured and configured, and that a VPN user is actually using a preferred or expected platform. For example, if a user's private data is stolen and used in other devices, the VPN server is typically unable to notice and prevent the user's private data from being used maliciously. In addition, such verification would prevent a hacker with a stolen smart-card but without a valid device the hacker would be prevented from accessing the enterprise network. Conversely, storage of secure data, such as user private data (e.g., user private key or the like), is not protected from access by malicious applications installed at the VPN terminals. In addition, no secure means exists to associate the user's certificate with the compromising platform. While some existing measures have been taken to store secure data more securely, (e.g., using a key storage protected by a password, creating a directory with strict permission, and the like) none of these measures is an integral solution for ensuring the security amongst the components and the platform, as a whole. These two problems can be overcome by making use of TCP technology.

Thus, the need exists to provide for a novel VPN system that provides improved trust. Additionally, the need exists to develop a VPN system that can manage different vendor provided devices securely and control the access of enterprise-confidential data, even in instances in which the user is disconnected from the VPN. The desired methods and systems should follow and be compatible with the current industry trend and provide a VPN solution that is built upon root-trust module platforms. In addition, the desired methods and systems should leverage the advantages of TCP to overcome existing security problems.

### BRIEF SUMMARY OF THE INVENTION

The present invention provides for a VPN system that comprises a plurality of terminals, sevices and servers, part or all of which are root-trust module based platforms. The system provides the management of root-trust based platforms in the network, and enables verification among the platforms.

The VPN system of the present invention provides four major functions. First, the system provides for a management server that manages the root-trust information (e.g., certificates) of the computing platforms in the network. The management server stores the root-trust information of the platforms in a local storage and is able to provide the root-trust information of any platform to other platforms upon requests in order for the verification of trust on a local platform or remote platforms. The management server also maintains trust restrictions on different platforms according to the security policy applied by the VPN owner. The trust restrictions are attached to the root-information of different devices and indicate the expected conditions that the device platform has to fulfill for trust device platform verification and control. The trust restrictions can also be configured at the management server in order to ensure and maintain trust relationships among different vendor devices. In addition, the management server may collect distrust notifications/warnings from the user terminals and perform a decision process to determine if terminating the VPN connection of the user terminal is warranted.

Second, the root-trust module based platform of the present invention is able to request root-trust information and trust restrictions of local platforms or remote platforms from the management system. In requesting root-trust information, the platform is also able to challenge and verify the remote platforms. By applying the trust restrictions into the root trust module, the challenging platform can ensure that the remote platform will function according to the VPN owner's specifications.

Thirdly, the root-trust module based platform of the present invention is able to manage the security of the platform all the time, e.g., verifying codes when the codes are installed and loaded, verifying the root-trust of remote platforms before and/or during communication, etc. The platform of the present invention also ensures that the VPN user terminal platform is the VPN owner trusted platform during the duration of the VPN connection. The present invention restricts the untrusted change of the terminal hardware and software according to the VPN's connection requirements (i.e., trust restrictions); therefore, a VPN trusted connection is insured throughout the entirety of the connection.

Fourthly, with the root-trust module, more security related services can be provided. For example, in order to prevent crucial data (e.g. confidential files saved locally from the VPN) from being accessed in the VPN disconnection status, the usage of the data can be controlled under the root-trust module. This aspect of the invention is especially meaningful in that the employees of a company can safely use their company devices, in which company confidential data is stored, in an extranet environment (e.g., the Internet) without the potential for disclosing the crucial data to network hackers. Without this level of protection, the company devices are vulnerable to hackers via the Intranet and are also vulnerable to internal disloyal and malicious employees.

In general, the invention proposes a trust management system in a VPN context. The system aims to manage trust-related operations among devices in the network so that setting up trust across devices and between different components of a device (e.g., between applications and operating systems) is possible. In particular, the system of the present invention ensures the execution of local platforms and remote terminal platforms by applying trust restrictions into the root-trust module of platforms. Thus, the invention overcomes the problems related to multiple vendor support in a VPN system. In addition, the invention offers advanced control of confidential data based on the root-trust module after the VPN connection is terminated. Therefore, the invention provides enhanced security for a VPN network and provides confidence to users of VPN services.

The invention is compatible with current TCP technology; however, the invention is not limited to current TCP technology and may be future TCP technology or other similar technologies. The compatibility with current TCP technology allows for the invention to leverage the advantages of TCP, such as secure storage of private data and the like.

Moreover, the invention allows for verification of remote computing platforms. For example, if a hacker attempts to break into the VPN with a fraudulently procured user private key, the hacker will be unable to break into the network with any other platform other than the verified platform. This is because the invention is able to associate a user's identity with a specific platform, which means the user can access the network only with that specific platform. The association between a user and a platform is managed by the system of the invention.

In one embodiment of the invention, a root-trust-based computer platform for implementation in a mobile terminal that requires Virtual Private Network (VPN) connectivity is defined. The platform includes a root-trust layer that includes a root-trust hardware component, an operating system layer that implements trust verification of an operating system and establishes root-trust between the operating system and the root-trust hardware component; and an application layer that implements trust verification of one or more applications and establishes root-trust between the one or more applications and the operating system. The root-trust hardware component limits further components in the platform to those which are trusted. This platform implements trust verification and establishes trust with a platform pair. In this regard trust can be established between devices regardless of device origin or other non-similar features.

The root-trust hardware component may take the form of a microprocessor or any other semiconductor device or devices. In addition, the root-trust hardware component will typically be designed so as to be tamper-resistant.

The platform of the present invention provides for trust management during trust domain connection and during trust domain disconnection. For example, the platform may provide for trust management during VPN connection and disconnection. Trust management may include, but is not limited to, verifying trust, setting up trust and maintaining trust amongst devices, operating systems and applications.

The invention is also embodied in a network system that a root-trust based computing platform. The system includes a plurality of devices that implement a root-trust based computing platform and reside in one or more trust domains and a trust domain management server that is in communication with the plurality of devices through a secure channel, wherein the server stores root-trust information of device platforms in a local storage and manages the root-trust information of all the plurality of devices.

The trust domains of the system may be defined as a VPN, a trusted network service, such as an electronic commerce service or the like, an intranet, such as a corporate intranet or the like.

The root-trust information stored by the server may included, but is not limited to, root-trust hardware component authentication certificates, operating system authentication certificates, application authentication certificates and electronic signatures.

The invention is also embodied in a method for obtaining root-trust based policy in a mobile terminal from a trust domain implementing a root-trust based computing platform. The method includes the steps of communicating a root-trust policy request from a mobile terminal to a trust domain management server, requesting, by the trust domain management server, an authentication from the mobile terminal and communicating authentication information from the mobile terminal to the trust domain management server. Additionally the method includes verifying, at the trust domain management server, that the authentication information is trusted, communicating one or more root-trust policy files from the trust domain management server to the mobile terminal and storing the one or more root-trust policy files in a trusted mobile terminal memory unit.

The invention is also embodied in a mobile terminal device that includes a root-trust based hardware component, an operating system that establishes root-trust with the root-trust based hardware component, verifies trust and maintains trust throughout operating system execution and one or more applications that establish root-trust with the operating system, verify trust and maintain trust throughout application execution.

Thus, the present invention provides for a VPN system with improved security. Improved security is realized by supporting trust management over the entire VPN system based on the root-trust modules that are embedded in various network devices. This trust management is realized by enforcing trust rules (trust restrictions on different platforms according to platform root-trust module information) into different devices during and after VPN connection. Hence, the invention provides prevention of the usage of user private data by malicious users on other platforms through ensuring two layers of security check and control: user verification and terminal trust verification and enforcement. Moreover, the present invention extends the security control on confidential data accessed from the VPN after the disconnection. In short, the invention keeps VPN trust on the connected terminal always, even though the connection is terminated.

The present invention is an integral solution establishing and managing the root-trust computing platforms of VPNs. The invention targets the trusted VPN connection not only with users, but also with the user's terminal. In addition, the present invention offers a simple flexible architecture to set up a VPN based on the root-trust based platforms. In this regard, the present invention allows managing non root-trust based platforms so that existing VPNs can easily migrate into VPNs based on the root-trust based platforms.

### BRIEF DESCRIPTION OF THE DRAWINGS

Having thus described the invention in general terms, reference will now be made to the accompanying drawings, which are not necessarily drawn to scale, and wherein:

FIG. 1 is schematic drawing of a Virtual Private Network in an Internet environment, in accordance with the prior art.

FIGS. 2A and 2B are block diagrams of a conventional architecture and computing platform that is non root-trust module based, in accordance with the prior art.

FIGS. 3A-3C are block diagrams of a root-trust based computing platform, in accordance with an embodiment of the present invention.

FIG. 4 is schematic drawing of a Virtual Private Network implementing a root-based computing platform, in accordance with an embodiment of the present invention.

FIG. 5 is a block diagram of the overall architecture of a VPN system implementing a root-trust computing platform, in accordance with an embodiment of the present invention.

FIG. 6 is a block diagram of a method for maintaining trust at a VPN device, in accordance with an embodiment of the present invention.

FIG. 7 is a schematic diagram of a mobile VPN implementing a root-trust based computing platform, in accordance with an embodiment of the present invention.

FIG. 8 is a schematic diagram of an alternate embodiment of a mobile VPN implementing a root-trust based computing platform, in accordance with an embodiment of the present invention.

FIG. 9 is a schematic diagram of a mobile VPN implementing a root-trust based computing platform implementing a method for verification/trust, in accordance with an embodiment of the present invention.

FIG. 10 is a flow diagram depicting a method for initiation of a trust chain during device start-up, i.e., booting, in accordance with an embodiment of the present invention.

FIGS. 11A-11C are flow diagrams depicting a method for sustaining trust after a device has booted, also referred to herein as up-chain trust sustainment, in accordance with an embodiment of the present invention.

FIGS. 12 and 13 are a flow diagram depicting a method for dynamic up-trust chain establishment and sustainment at the application/service level, in accordance with an embodiment of the present invention.

FIG. 14 is a flow diagram depicting a method for sustaining trust after an application bundle has been installed, in accordance with an embodiment of the present invention.

FIG. 15 is a flow diagram depicting a method for establishing trust between different entities in the trust environment, in accordance with an embodiment of the present invention.

FIG. 16 is a flow diagram depicting a method for embedding the trusted community conditions in different trust chains, in accordance with an embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention provides for a VPN system that comprises a plurality of terminals, services and servers, part or all of which are root-trust module based platforms. The system provides the management of root-trust based platforms in the network, and enables verification among the platforms.

The VPN system of the present invention provides four major functions. First, the system provides for a management server that manages the root-trust information (e.g., certificates) of the computing platforms in the network. The management server stores the root-trust information of the platforms in a local storage and is able to provide the root-trust information of any platform to other platforms upon requests in order for the verification of trust on a local platform or remote platforms. The management server also maintains trust restrictions on different platforms according to the security policy applied by the VPN owner. The trust restrictions are attached to the root-information of different devices and indicate the expected conditions that the device platform has to fulfill for trust device platform verification and control. The trust restrictions can also be configured at the management server in order to ensure and maintain trust relationships among different vendor devices. In addition, the management server may collect distrust notifications/warnings from the user terminals and perform a decision process to determine if terminating the VPN connection of the user terminal is warranted.

Second, the root-trust module based platform of the present invention is able to request root-trust information and trust restrictions of local platforms or remote platforms from the management system. In requesting root-trust information, the platform is also able to challenge and verify the remote platforms. By applying the trust restrictions into the root trust module, the challenging platform can ensure that the remote platform will function according to the VPN owner's specifications.

Thirdly, the root-trust module based platform of the present invention is able to manage the security of the platform all the time, e.g., verifying codes when the codes are installed and loaded, verifying the root-trust of remote platforms before and/or during communication, etc. The platform of the present invention also ensures that the VPN user terminal platform is the VPN owner trusted platform during the duration of the VPN connection. The present invention restricts the untrusted change of the terminal hardware and software according to the VPN's connection requirements (i.e., trust restrictions); therefore, a VPN trusted connection is insured throughout the entirety of the connection.

Fourthly, with the root-trust module, more security related services can be provided. For example, in order to prevent crucial data (e.g. confidential files saved locally from the VPN) from being accessed in the VPN disconnection status, the usage of the data can be controlled under the root-trust module. This aspect of the invention is especially meaningful in that the employees of a company can safely use their company devices, in which company confidential data is stored, in an extranet environment (e.g., the Internet) without the potential for disclosing the crucial data to network hackers. Without this level of protection, the company devices are vulnerable to hackers via the Intranet and are also vulnerable to internal disloyal and malicious employees.

According to the invention, the establishment of trusts between devices, particularly mobile devices includes several aspects. First, primary trust chain establishment must occurring during booting of the device. This is establishment is the basis for what is referred to herein as the up-trust chain. Once established, the up-trust chain must be sustained after booting. Sustaining trust involves insuring that changes or updates to the operating system can be trusted. An upper level, such as the OS level, will report to the lower level, such as the root-trust layer level, the need for change/update and the lower level will grant permission for the change/update. This addresses the need for system level trust management.

In addition to the primary system level trust chain, trust management will also typically be necessary at the application level. Dynamic up-trust chain establishment and sustainment at the application/service level will typically occur. In terms of establishment, after identifying whether to trust or to distrust an application, the device should authorize the application access permission and assign operation policies to the application. As previously discussed, sustaining trust will involve the upper level, such as the application level, reporting to the lower level, such as the operating system level, the need for change/update and the lower level will grant permission for the change/update. The change permission should be checked at both legacy application level and the OS level in order to be consistent with both level's security. Another reason is that it is the OS that handles some application permissions and operation policies. In addition, the authorized permission and operation policy assigned to the applications may be registered at the application trust manager for later trust sustainment purpose. In addition, down-trust chain support, if needed, may be required to provide trust in other applications and services.

The invention is established and maintained based on the following two principles. The first is up-trust chain establishment and maintenance. The up-trust chain is established by trust ensured booting based on the signature verification by root certificate. In this way, the basic trust chains are built after booting. In each chain the lower level component (otherwise referred to herein as the trustor of the chain) builds up, i.e., initiates, trust on its immediate upper layer component/components (trustee of the chain). After booting, the trust sustainment of the trust chains is based on the trustor's control of any behavior that may influence the trust relationship. Permission should be achieved by any device component (trustee) from its trustor in order to do any changes at the trustee in each chain. The trust chain on the mobile application level is built from OS/legacy applications based on valid digital signature check. Access permissions are issued based on the application's permissions and signature-attached domain's permissions.

The second principle is down-trust establishment and maintenance. This includes two parts. One is the trusted community establishment between device and its remote platform based on the device's root trust module (e.g. device secure main chip). The other is ensuring the trusted community's conditions through embedding them into the device trust chains' trustor components accordingly.

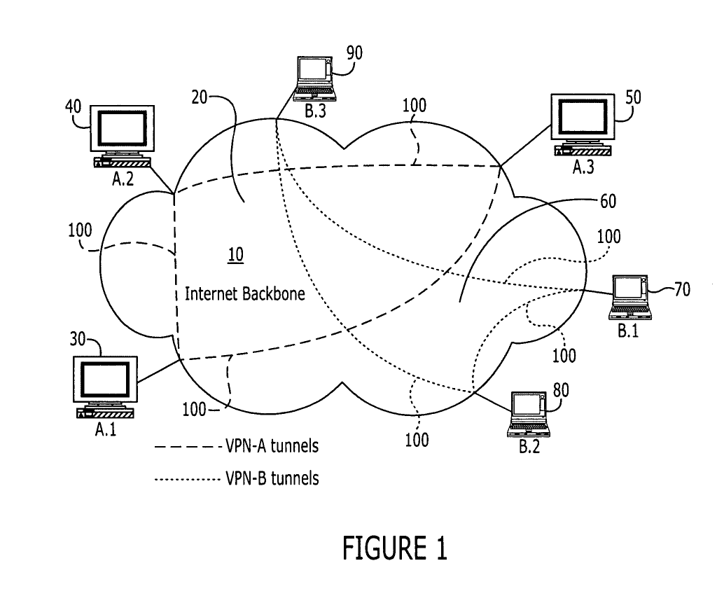

FIG. 1 provides a schematic representation of VPNs in an Internet Environment, in accordance with the prior art. In the illustrated embodiment two VPNs are defined that utilize the Internet 10 as the network backbone. The first VPN 20 includes clients 30, 40 and 50. The second VPN 60 includes clients 70, 80 and 90. In either VPN, two clients of the VPN are connected through a VPN tunnel 100. The VPN is built by connecting all clients of the VPN through the use of VPN tunnels. In most VPN networks, the tunnels are considered to be strongly secured through the Internet Protocol Security (IPSec). IPSec provides for a tunnel mode that encrypts both the header and payload portions of the IP packet and IPSec compliant receiving devices decrypt the packets. In this security mode the sending and receiving devices share a public encryption key. The receiving device obtains a public key and authenticates the sending device using digital certificates.

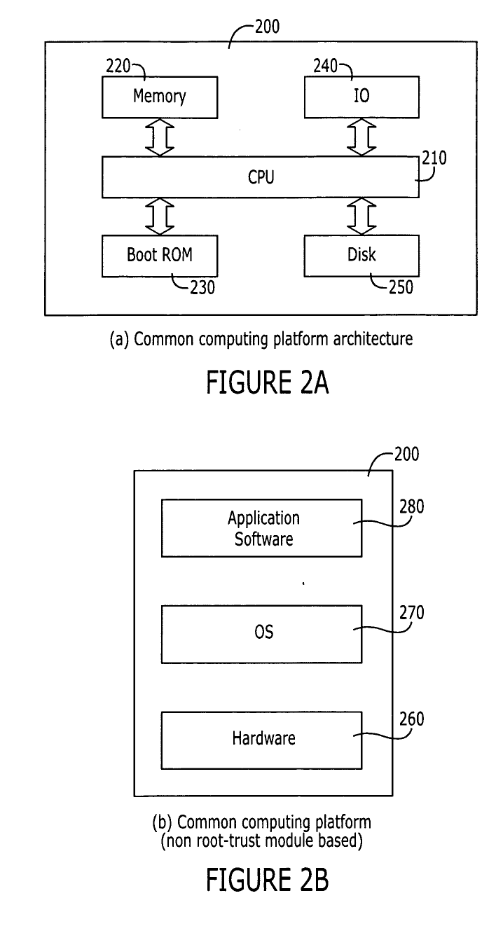

FIGS. 2A and 2B provide block diagrams that present a common computing platform architecture and a computing platform that are non root-trust module based, in accordance with the prior art. FIG. 2A provides a block diagram that presents the computing hardware architecture of the platform 200 that includes a processing device, such as Central Processing Unit (CPU) 210 in communication with a device memory 220, boot Read Only Memory (ROM) 230, input/output device 240 and hard disk 250. In addition the CPU will typically be in communication with other ancillary devices that provide additional functions to the computing device. FIG. 2(b) provides a block diagram that illustrates the workable computing platform 200 including three layers, i.e., hardware 260, operating system (OS) 270, and application software 280. However, as shown in FIGS. 2A and 2B, no trust verification and/or set up between the layers exists in this conventional prior art platform.

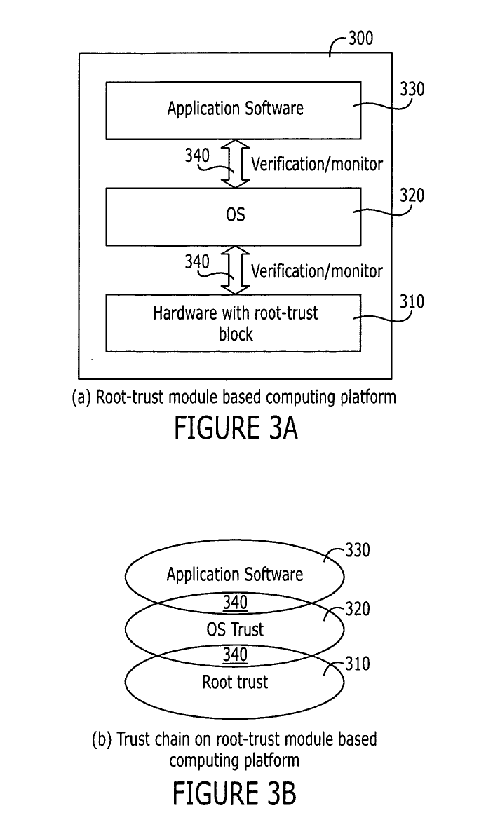

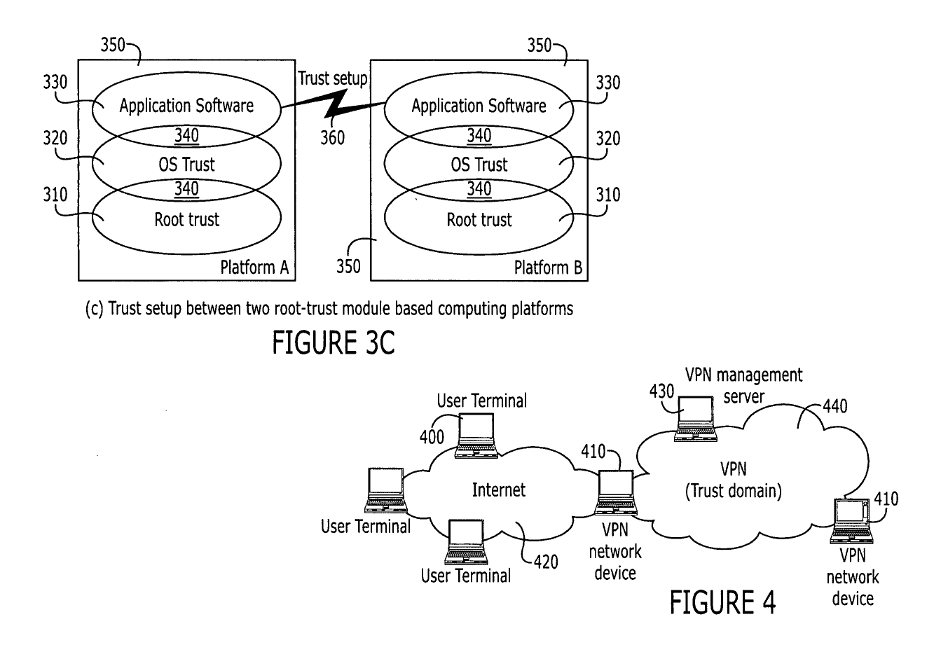

In accordance with an embodiment of the present invention, FIGS. 3A-3B provide block diagrams of the root-trust based computing platform. FIG. 3A shows the platform 300 including layers for hardware 310 with root-trust block, operating system 320 and application software 330. In this platform trust verification/monitoring 340 is done between layers so as to set up a trust chain among the layers. The concept of the trust chain is shown in FIG. 3B, in which the root-trust hardware 310, the operating system 320 and application software 330 are interconnected by the trust verification/monitoring 340, otherwise referred to as the trust chain. FIG. 3C presents trust establishment between two root-trust based computing platforms. Platform A 350 needs to verify the root-trust of platform B 360 before it can establish trust with platform B. This verification is depicted in the FIG. 3C embodiment as trust setup 360. The trust verification of root-trust is done through upper layers (in this instance the application layer) and then proceeds within the platform down the layers, first to the OS trust layer and then to the root-trust layer (i.e., the bottom layer). Through the trust verification and establishment of the root-trust, platform A and platform B can verify the root-trust of the other platform (i.e., platform A can verify the root-trust of Platform B and platform B can verify the root-trust of Platform A).

FIG. 4 illustrates a schematic diagram of a VPN implementing a root-trust based computing platform, in accordance with an embodiment of the present invention. A plurality of user terminals 400 are in network communication with a VPN access network device 410 via the Internet 420. A plurality of VPN network devices 410 and a VPN management server 430 are within the confines of the VPN 440, which is a trust domain. As such, both the user terminals and the network devices are root-trust based computing platforms so that verification and establishment are required between the user terminals and the network devices. Note that the user terminals can be all kinds of terminals, e.g., PC, mobile phone, etc. In certain embodiment it may be necessary to carry out the verification and establishment of the root-trust among network devices when the VPN is being established. The VPN management server 430 is responsible for providing the necessary information to the user terminals and the network devices to carry out the root-trust verification.

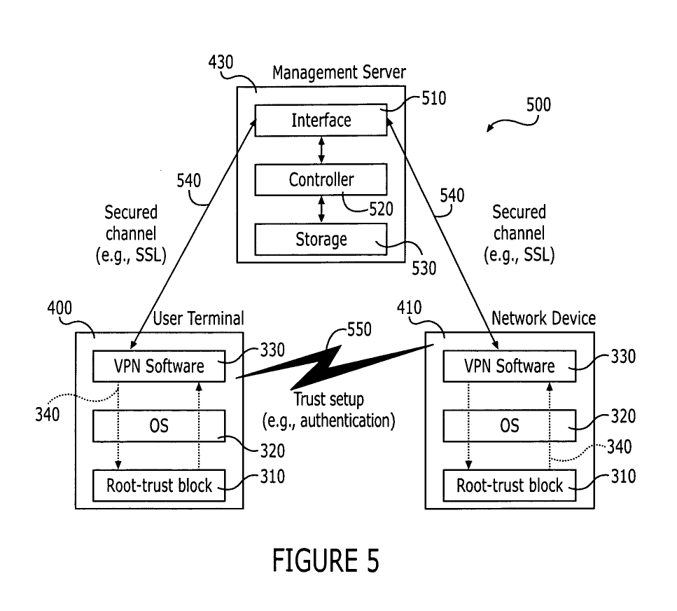

FIG. 5 is illustrates a block diagram depicting the architecture of the VPN system 500 implementing a root-trust based computing platform, in accordance with an embodiment of the present invention. As shown in FIG. 5, the VPN management server 430 provides an interface 510 from which both user terminal 400 and network device 410 are able to request necessary information (e.g., certificate of root-trust of remote platform and the like) to carry out the verification of the root-trust module based platform. A controller 520 in the VPN management server is in communication with the interface 510 and local storage 530. The controller provides control over requests received via the interface from other devices in the VPN and control over the access and storage of data in the local storage. The local storage 530 serves to store the root-trust information of all platforms in a local storage and manages the root-trust information of all terminals and devices in the VPN. The connections between either user terminals or network devices and the management server are secured channels 540 through which either user terminals or network devices are able to get the root-trust information of remote platforms for trust verification. One example of a secure channel protocol is Secure Socket Layer (SSL) protocol, although other similarly functional secure channels may be used.

The block diagram depictions of the user terminal 400 and the network device 410 are functionally similar to the depiction shown in FIG. 3C. User terminal 400 needs to verify the root-trust of network device 410 before it can establish trust with the network device. This verification is depicted in the FIG. 3C embodiment as trust setup or authentication 550. The trust verification of root-trust is done through upper layers (in this instance the VPN application layer 330) and then proceeds within the platform down the layers, first to the operating system layer 320 and then to the root-trust layer 310 (i.e., the bottom layer). Through the trust verification and establishment of the root-trust, the user terminal and network device can verify the root-trust of the other device (i.e., the user terminal can verify the root-trust of network device and network device can verify the root-trust of the user terminal).

The user terminal 400 and the network device 410 can establish trust by initiating communication with each other and exchanging root-trust information for the purpose of authentication. The terminal or the network device may need to communicate with the server 430 to obtain or verify the root-trust of either the terminal or the device. Both the terminal and the device will rely on a root-trust based hardware component that resides in the root-trust layer of the device and terminal platforms to establish the trust between the device and the terminal.

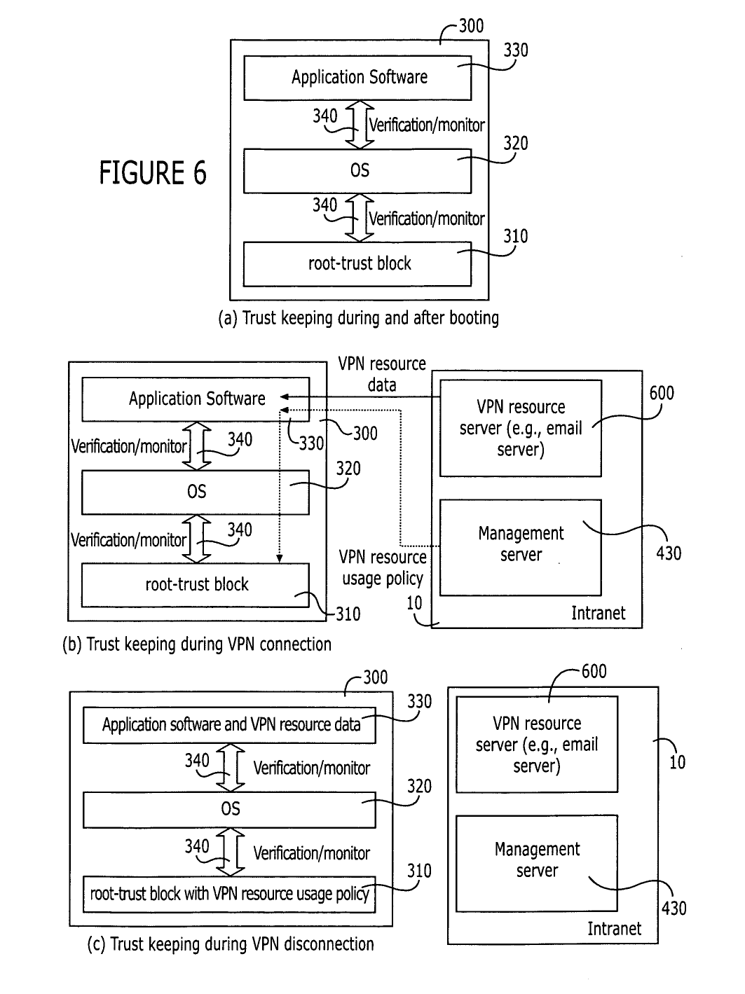

FIGS. 6A-6C illustrate block diagram of the configurations for maintaining trust in a VPN system at various stages, in accordance with an embodiment of the present invention. The invention applies to maintaining trust at all stages of device activity procedures, such as during and after the booting (FIG. 6A), during the VPN connection (FIG. 6B), and during the VPN disconnection (FIG. 6C). As shown in FIG. 6A, during and after the booting of the device 300, the root-trust block 310 of the device verifies and monitors any changes and/or operations occurring at the operating system layer 320, the application layer 330 or elsewhere on the platform. The root-trust block is then able to detect/restrict disallowed actions or changes if necessary. As shown in FIG. 6B, during the VPN connection, the device accesses VPN resource server 600 via the Intranet 410 (e.g., email server and the like) to obtain VPN resource data (e.g., emails, company confidential documents, VPN management data and the like). Meanwhile, the device also accesses the VPN management server 430 via the Intranet 10 to obtain the usage policies of the VPN resource data so that the root-trust block can monitor the usage of the data and the operations of the device seamlessly and continuously. Further, the root-trust block 310 could also monitor the platform 300 components and operations accordingly. As shown in FIG. 6C, the root-trust block 310 could further monitor the platform 300 component and restrict disallowed operations on the data and device according to the usage policies after the VPN connection has been disconnected.

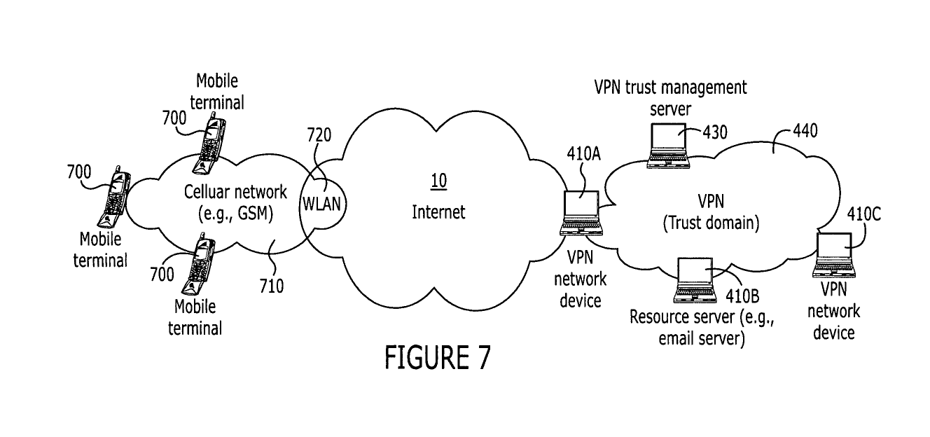

In accordance with further embodiments of the present invention, the VPN based on a root-trust computing platform is also applicable for mobile networks. FIG. 7 illustrates a schematic diagram of the VPN based on a root-trust computing platform used in mobile networks (e.g., Global System for Mobile Communications (GSM) networks and the like), in accordance with an embodiment of the present invention. In this embodiment, VPN users use their mobile terminals 700 to connect to an enterprise VPN 440 and access VPN services 410B or 410C (e.g., emails, file sharing, etc.) through the VPN device 410A, which is connected to the Internet 10. The mobile terminals connect to the Internet 10 via the cellular network 710 through wireless access technology 720 (e.g., WLAN or the like).

The VPN trust management server 430 manages the root-trust related mangement issues for the mobile terminals. Notably, the server may reside inside the VPN or in the Internet (protected by a firewall). The server will instruct how the mobile terminals can use their root-trust and for what operations. Meanwhile, the server is able to push/pull policy changes to the mobile terminals 700 in a secure, fast and convenient way (e.g., through SSL). With the help of the server, the mobile terminals can more securely and easily setup trust with other trust entities including other mobile terminals and VPN devices. Therefore, they are able to easily setup and maintain trust relationship during VPN operations and even beforehand (i.e., at device start-up) and afterwards (after the VPN session has been disconnected).

In particular, with the policies that the mobile terminal 700 obtains from the management server 430, the terminal's root-trust module with other ancillary modules (e.g., trust storage) are able to keep and maintain trust relationship in the terminal, e.g., allow or refuse to install an application, etc.

Note that although the invention only mentions one trust management server, the server itself may comprise a number of servers that make the overall system functional. For example, a Personal Identification Number (PKI) server that generates certificates for the mobile terminals can be included in those systems that warrant such.

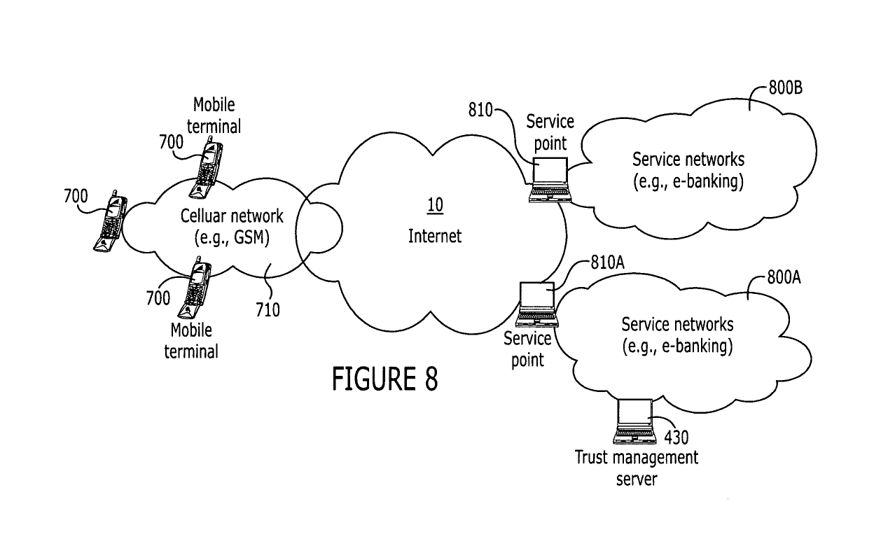

FIG. 8 illustrates another application of the VPN based on a root-trust computing platform in mobile networks, in accordance with an embodiment of the present invention. In FIG. 8 users with mobile terminals 700 are afforded additional services beyond standard VPN services. For example, a user may be afforded, m-commerce services (e.g., e-banking). The mobile terminal may access a service network 800A, and specifically a management server 430 in the network, via the Internet 10 through a service point 810A. The mobile terminal receives policies from the trust management server 430, which is securely protected. The policies may specify many things, e.g., usage of the root-trust, service point addresses, valid software, etc. Once a terminal receives the policies, each terminal is able to connect to a service point 810A and carry out e-commerce services via the service network 800B. In the FIG. 8 embodiment two separate service networks are illustrated to show, by way of example, that they are located in distinct areas of the network. The networks are typically interconnected by VPN tunnels, which serve to comprise a comprehensive VPN network. The service networks may be, for example, a VPN network, such as a company intranet or the like.

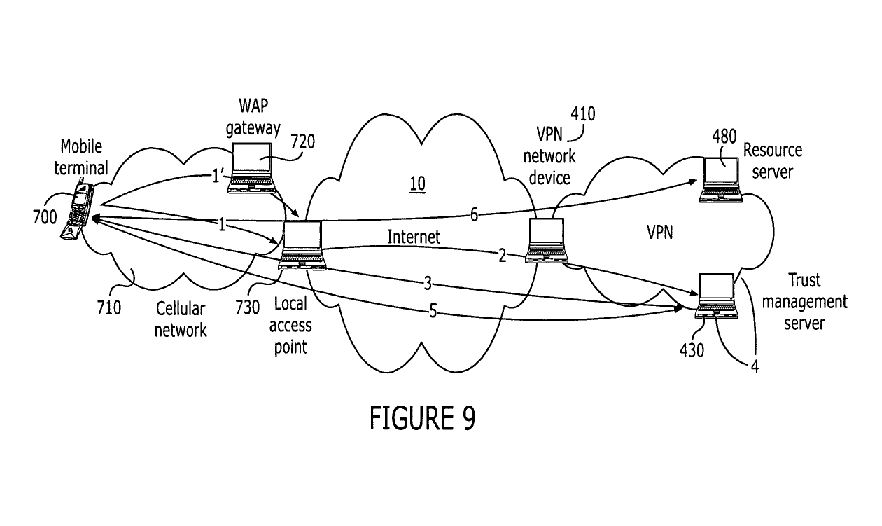

FIG. 9 illustrates an example of an implementation/method through which a mobile terminal with root-trust module can obtain a trust policy from the management server. However, the invention itself is not limited to this implementation/method. The implementation/method comprises the following steps. A mobile terminal 700 (e.g. such as a cellular telephone) connects to (or gains access via Wireless Access Point (WAP) 720) to a local access point 730 through the cellular network 710. The local access point 730 forwards the request to the VPN management server 430. Such forwarding of the request to the server may occur via the Internet 10 and through VPN network device 410 that serves as a gateway to the VPN 400. Note that the terminal may also be able to connect to the VPN management server 430 directly without passing through the local access point. The management server 430 challenges the terminal 700 over a secure channel (e.g., SSL) for authentication. The terminal may also require information from the management server for server authentication. Once the authentication succeeds, the terminal sends the terminal's information to the server, if requested by the server. The terminal information may include platform configuration certificate, the mobile terminal unique platform ID and the like.

The management server 430 will verify the documents as trusted. Then, the management server 430 issues one or more policy files to the terminal. The terminal can use the policy files to connect to the intranet services, for example, resource server 480.

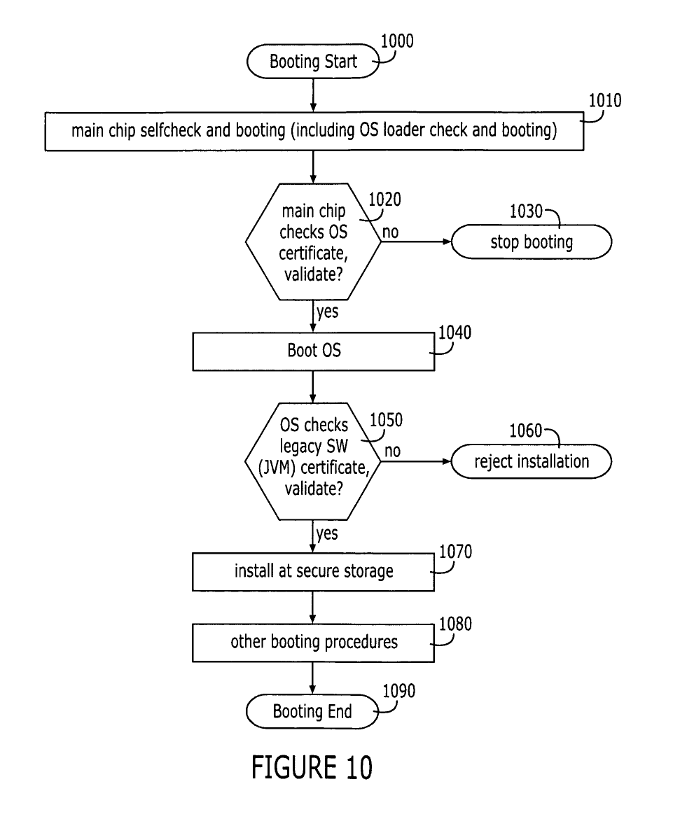

FIG. 10 provides a flow diagram of a method for initiation of a trust chain during device start-up, i.e., booting, in accordance with an embodiment of the present invention. At step 1000, the boot process is initiated by powering-up the device, such as a mobile terminal device. At step 1010, the main chip or chipset of the device performs a self-check and a boot function. At determination step 1020, a determination is made as to whether the operating system is valid. This step involves having the main chip or chipset check to insure that a proper operating system certificate has been recorded, i.e., stored. Typically, the verification of the certificate will occur via communication with the external trust domain management server, such as a VPN management server. If no certificate is located and the operating system can not be validated then, at step 1030, the booting of the device is stopped.

If the certificate is located and, thus, the operating system is validated then, at step 1040, the operating system is booted. At step 1050, a determination is made as to whether a legacy application implemented on the device is valid. The device may implement multiple legacy applications either on start-up or at user request and, thus, multiple trust verifications may be required. This step involves having the operating system check to insure that a proper legacy application certificate has been recorded, i.e., stored. If no certificate is found and a legacy application can not be validated then, at step 1060, the installation or start-up of the legacy application is stopped, i.e., rejected. If the certificate is located and, thus, the application is validated then, at step 1070, the application is installed at a secure memory site or the application is properly booted, if previously installed. At step 1080, other booting procedures that do not involve trust verification are administered and at step 1090 the booting process is completed and terminated.

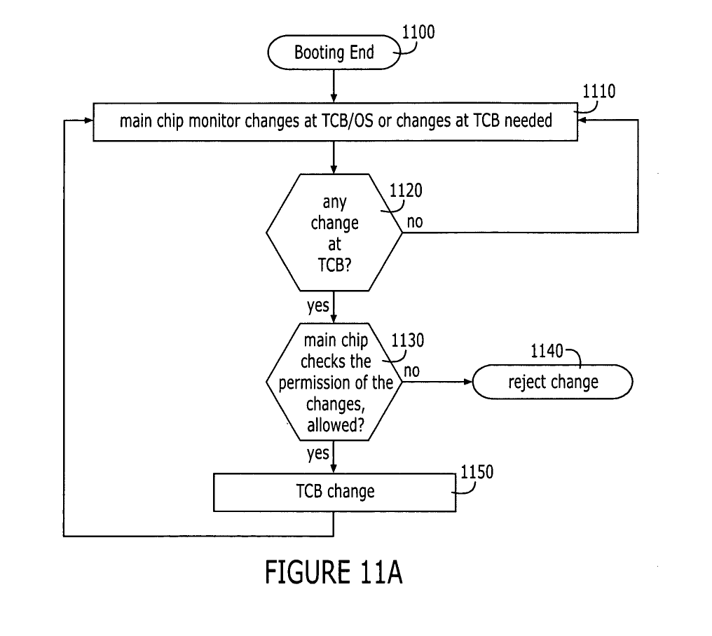

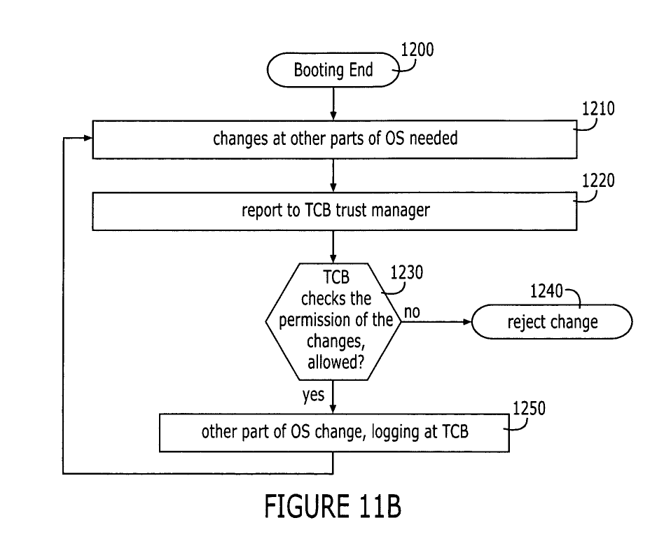

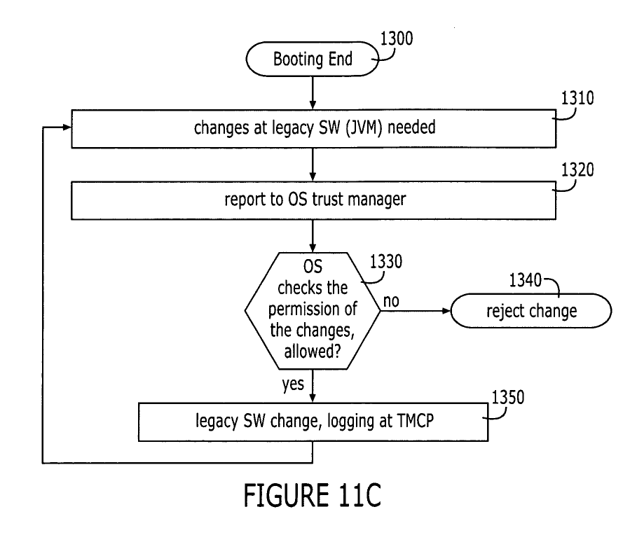

FIGS. 11A-11C provides a flow diagram of a method for sustaining trust after a device has booted, also referred to herein as up-chain trust sustainment, in accordance with an embodiment of the present invention. Referring to FIG. 11A a flow for monitoring changes at the trusted computing base is illustrated. At step 1100, the booting process has ended and, at step 1110, the main chip or chip set monitors changes at the trusted computing base (TCB) or the TCB/OS level. At step 1120, a determination is made as to whether a change to the TCB is forthcoming and, if no change forthcoming then monitoring continues at step 1110. If a change is forthcoming then, at step 1130, the main chip or chip set checks to determine if permission is granted for changes to the TCB or TCB/OS. If no changes are permitted then, at step 1140, the change is rejected. If the change is permitted then, at step 1150, the change is administered and the process returns to step 1110 for further monitoring.

Referring to FIG. 11B a flow for monitoring changes at the operating system level is illustrated. At step 1200, the booting process has ended and, at step 1210, the main chip or chip set monitors changes at the operating system level/OS level and if a change is forthcoming then, at 1220, reports the change to the TCB trust manager. At step 1230 a determination is made by the TCB to determine if permission is granted for changes to the operating system. If no changes are permitted then, at step 1240, the change is rejected. If the change is permitted then, at step 1250, the change is administered and logged at the TCB. Once the change is administered, the process returns to step 1210 for further monitoring.

Referring to FIG. 11C a flow for monitoring changes at the application level is illustrated. At step 1300, the booting process has ended and, at step 1310, the operating system monitors changes at the legacy application level and if a change is forthcoming then, at 1320, reports the change to the operating system trust manager. At step 1330 a determination is made by the operating system to determine if permission is granted for changes to the legacy application. If no changes are permitted then, at step 1340, the change is rejected. If the change is permitted then, at step 1350, the change is administered and logged at the TCB. Once the change is administered, the process returns to step 1310 for further monitoring.

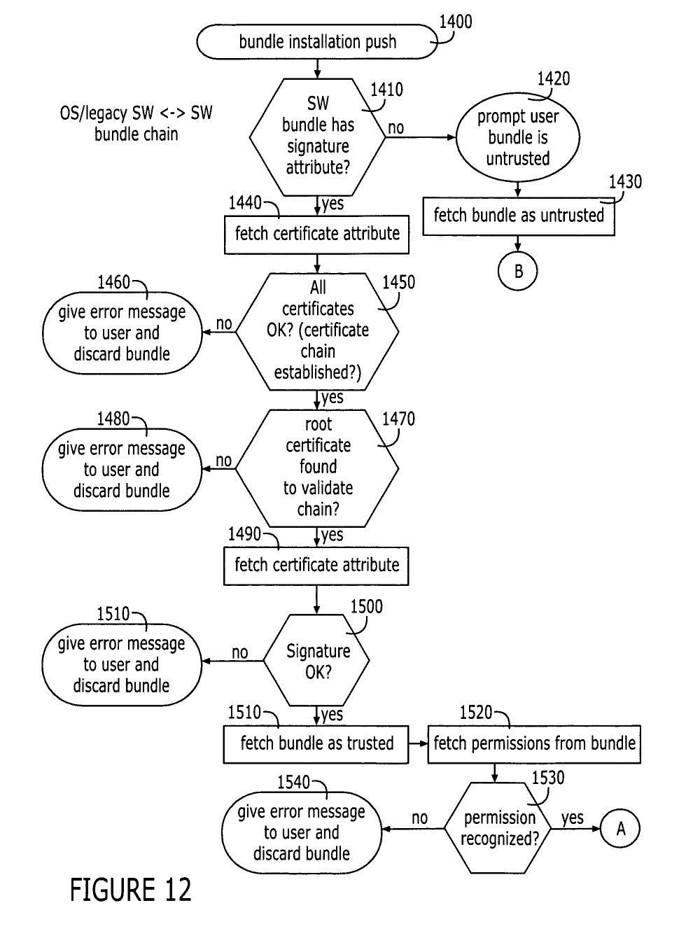

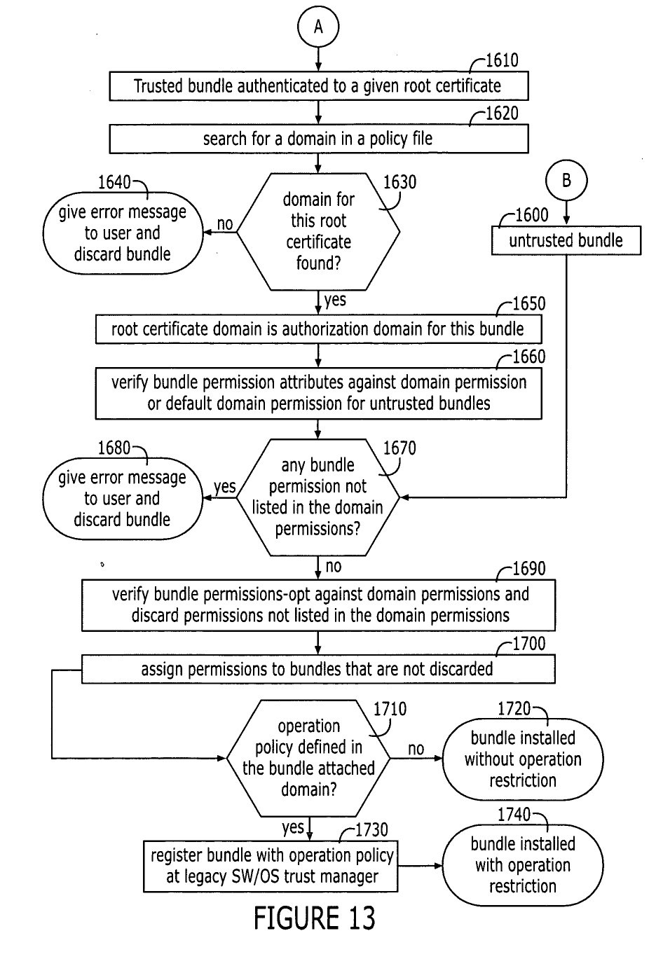

FIGS. 12 and 13 provide flow diagrams of a method for dynamic up-trust chain establishment and sustainment at the application/service level, in accordance with an embodiment of the present invention. This embodiment of the invention establishes the trust chain between legacy applications and application bundles, which are typically dynamically downloaded at installed at the legacy application.

At step 1400, the application bundle is pushed to the device from the network. At step 1410, a determination is made as to whether the bundle as a signature attribute. If no signature attribute is present, at step 1420, the user is prompted that the bundle is untrusted. If the user chooses to proceed, at step 1430, the untrusted application bundle is fetched. (The FIG. 12 flow designated by ‘B’ continues in FIG. 13). Referring to FIG. 13, at step 1600 the untrusted application bundle has been fetched. At step 1660, bundle permission attributes are verified against domain permission (default or otherwise) and at determination step 1670, a determination is made to determine bundle permission exists that does appear in the listed domain permissions. If it is determined that bundle permission exists and is not listed amongst the domain permissions then, at step 1680, an error message is provided to the user and the bundle is discarded. If the bundle permission exists in the list of domain permissions then, at step 1690, bundle permission-opt is verified against domain permissions and discard permissions not listed in the domain permissions. At step 1700, permissions are assigned to application bundles that are not discarded. At step 1710, a determination is made whether an operation policy is defined in the domain for the bundle. If no operation policy exists then, at step 1720, the bundle is installed without an operation restriction. If an operation policy does exist then, at step 1730, the bundle is registered with the operation policy at the legacy application/operating system trust manager and, at step 1740; the bundle is installed with the operation restriction.

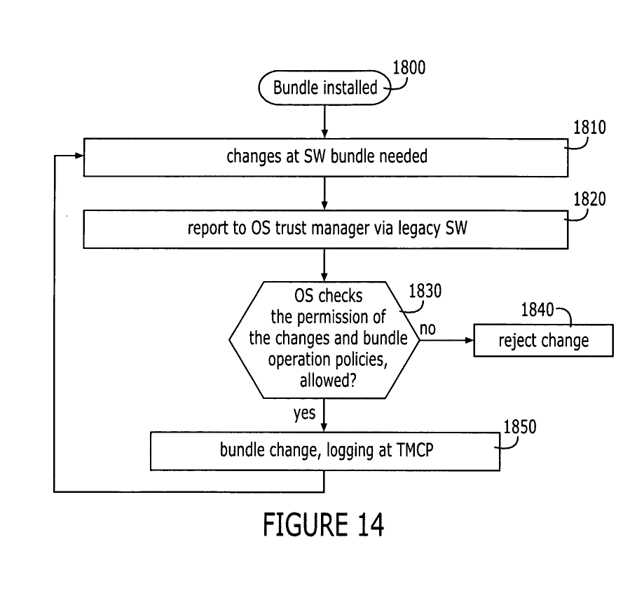

Referring again to FIG. 12, if the application bundle is determined, at step 1410, to have a signature attribute then, at step 1440, the certificate attribute is fetched. At step 1450, a check is made to determine if the certificate is established. If the certificate is not established then, at step 1460, the user is provided an error message and the application bundle is discarded. If the certificate is established then, at step 1470, a determination is made as to whether a root certificate exists to validate the chain. If no root certificate exists then, at step 1480, the user is provided an error message and the application bundle is discarded. If the certificate is established then, the signature attribute is fetched. At step 1490, a determination is made as to whether the signature is valid. If the signature is determined to be invalid, at step 1500, the user is provided an error message and the application bundle is discarded. If the signature is determined to be valid the, at step 1510, the application bundle is fetched as trusted and, at step 1520, the permissions are fetched from the trusted application bundle. At step 1530, a determination is made as to whether the permission is recognized. If the permission is not recognized, at step 1540, the user is provided an error message and the application bundle is discarded. If the permission is recognized the flow continues to FIG. 14 designated by “A”.

At step 1610, the trusted application bundle is authenticated to a given root certificate and, at step 1620, a search is conducted for a domain in a policy file. At step 1630, a determination is made as to whether a domain is found for the root certificate. If no root certificate domain is found then, at step 1640, the user is provided an error message and the application bundle is discarded. If a root certificate domain is found, at step 1650, the domain is assigned as the authorization domain for the application bundle and step 1660 ensues. Steps 1670-1740 will subsequent ensue as described above.

Once the application bundle has been installed, monitoring of changes will continue to insure trust. FIG. 14 provides a flow diagram for a method for sustaining trust after an application bundle has been installed, in accordance with an embodiment of the present invention. At step 1800, the bundle installation process has been completed and, at step 1810, the operating system monitors changes at the bundle application and if a change is forthcoming then, at 1820, reports the change to the operating system trust manager via the legacy application. At step 1830 a determination is made by the operating system to determine if permission is granted for changes to the bundle application. If no changes are permitted then, at step 1840, the change is rejected. If the change is permitted then, at step 1850, the change is administered and logged at the TCB. Once the change is administered, the process returns to step 1810 for further monitoring.

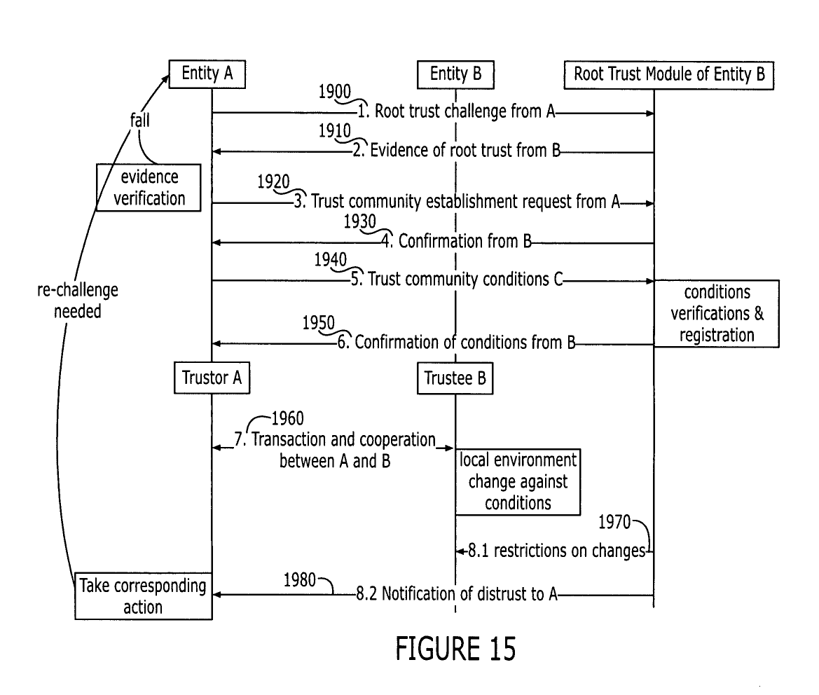

FIG. 15 provides a flow diagram of a method for establishing trust between different entities in the trust environment, for example in a mobile terminal network, in accordance with an embodiment of the present invention. The process is initiated, at step 1900, with Entity A providing a root trust challenge to Entity B. At step 1910, the root trust module of Entity B responds with evidence of root-trust. Entity A verifies the root-trust evidence and, if verified, a trust community establishment request is then sent, at step 1920, from Entity A to the root trust module of Entity B. At step 1930, the root-trust module of Entity B confirms establishment of the trust. Once the trust has been established, at step 1940, Entity A will communicate the trust community conditions to the root-trust module of Entity B. Entity B will verify the conditions and register, i.e., store the conditions, accordingly. At step 1950, the root-trust module of Entity B will confirm the trust community conditions. At this stage trust has been established between Entity A, the trustor and Entity B, the trustee. At step 1960, transactions and cooperation occur between Entity A and Entity B. If the local environment attempts to invoke a change at Entity, at step 1970, Entity B will check for change restrictions and invoke the restrictions as defined. If the conditions restrict the change, at step 1980, the root-trust module of Entity B will notify Entity A of the mistrust and take corresponding action, such as re-challenge, if needed.

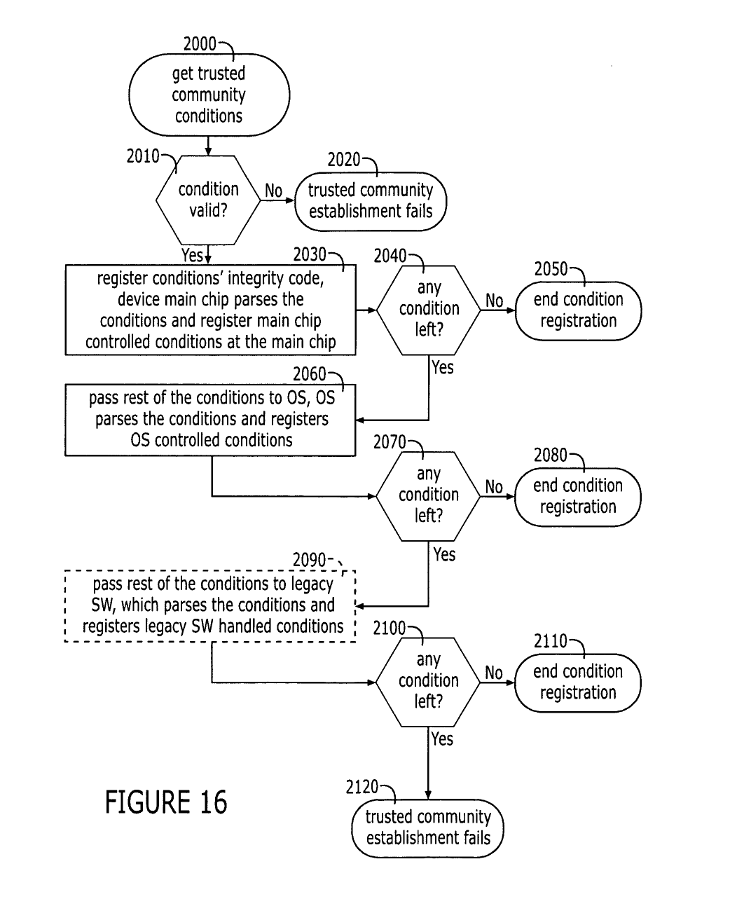

FIG. 16 provides a flow diagram of a method for embedding the trusted community conditions in different trust chains, in accordance with an embodiment of the present invention. At step 2000, a device receives trusted community conditions and, at step 2010, a determination is made as to whether the conditions are valid. If the conditions are determined to be invalid then, at step 2020, the trusted community establishment fails. If the conditions are determined to be valid then, at step 2030, the conditions' integrity code is registered, the conditions are parsed by the main chip and registers the main chip controlled conditions. At step 2040, a determination is made as to whether any conditions are left. If no conditions are left, at step 2050, the condition registration is complete. If further conditions remain, at step 2060, the conditions are passed to the operating system, the operating system parses the conditions and registers operating system controlled conditions. At step 2070, a determination is made as to whether any conditions are left. If no conditions are left, at step 2080, the condition registration is complete. If further conditions remain, at step 2090, the conditions are passed to the legacy applications, the legacy applications parse the conditions and registers legacy application controlled conditions. At step 2100, a determination is made as to whether any conditions are left. If no conditions are left, at step 2110, the condition registration is complete. If further conditions remain, at step 2120, the trusted community establishment is deemed to have failed.

Thus, the invention provides a trust management system in a VPN context. The system aims to manage trust-related operations among devices in the network so that setting up trust across devices and between different components of a device (e.g., between applications and operating systems) is possible. In particular, the system of the present invention ensures the execution of local platforms and remote terminal platforms by applying trust restrictions into the root-trust module of platforms. The invention overcomes the problems related to multiple vendor support in a VPN system. In addition, the invention offers advanced control of confidential data based on the root-trust module after the VPN connection is terminated. Therefore, the invention provides enhanced security for a VPN network and provides confidence to users of VPN services.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A root-trust-based computer platform for implementation in a mobile terminal that requires Virtual Private Network connectivity, the platform comprising:
a root-trust layer that includes a root-trust hardware component;
an operating system layer that implements trust verification of an operating system and establishes root-trust between the operating system and the root-trust hardware component; and
an application layer that implements trust verification of one or more applications and establishes root-trust between the one or more applications and the operating system;
wherein the root-trust hardware component limits further components in the platform to those which are trusted.

2. The platform of claim 1, wherein the platform provides for establishment of trust between two or more mobile terminal devices implementing the root-trust-based computer platform.

3. The platform of claim 1, wherein the root-trust hardware component is further defined as a microprocessor.

4. The platform of claim 1, wherein the root-trust hardware component is further defined as tamper-resistant.

5. The platform of claim 1, wherein the platform provides for trust management of the mobile terminal during Virtual Private Network connection.

6. The platform of claim 1, wherein the platform provides trust management of the mobile terminal during Virtual private network disconnection.

7. A network system that implements a root-trust based computing platform; the system comprising:
a plurality of devices that implement a root-trust based computing platform and reside in one or more trust domains; and
a trust domain management server that is in communication with the plurality of devices through a secure channel, wherein the server stores root-trust information of device platforms in a local storage and manages the root-trust information of all the plurality of devices.

8. The network system of claim 7, wherein one of the one or more trust domains is further defined as a Virtual Private Network.

9. The network system of claim 7, wherein one of the one or more trust domains is further defined as a trusted network service.

10. The network system of claim 9, wherein the trusted network service is further defined as an electronic commerce service.

11. The network system of claim 7, wherein one of the one or more trust domains is further defined as a corporate intranet.

12. The network system of claim 7, wherein the trust domain management server that stores root-trust information further defines the root trust information as chosen from the group of information consisting of root-trust layer hardware authentication certificates, operating system authentication certificates, application authentication certificates and electronic signatures.

13. A method for obtaining root-trust based policy in a mobile terminal from a trust domain implementing a root-trust based computing platform, the method comprising the steps of:
communicating a root-trust policy request from a mobile terminal to a trust domain management server;
requesting by the trust domain management server an authentication from the mobile terminal;
communicating authentication information from the mobile terminal to the trust domain management server;
verifying, at the trust domain management server, that the authentication information is trusted;
communicating one or more root-trust policy files from the trust domain management server to the mobile terminal; and
storing the one or more root-trust policy files in a trusted mobile terminal memory unit.

14. The method of claim 13, wherein the trust domain is further defined as chosen from among the group of trust domains consisting of a Virtual Private Network, a trusted network service and an intranet.

15. A mobile terminal device, the device comprising:
a root-trust based hardware component;
an operating system that establishes root-trust with the root-trust based hardware component, verifies trust and maintains trust throughout operating system execution; and
one or more applications that establish root-trust with the operating system, verify trust and maintain trust throughout application execution.
